(19) United States
(12) Patent Application Publication
(10) Pub. No.: US 2019/0230422 A1
(43) Pub. Date: Jul. 25, 2019

(54) INTELLIGENT MODEL FOR DYNAMICALLY SELECTING BEST TRANSMISSION CHANNEL

(71) Applicant: VeriFone, Inc., San Jose, CA (US)

(72) Inventor: Imran A. HAJIMUSA, San Jose, CA (US)

(21) Appl. No.: 15/876,425

(22) Filed: Jan. 22, 2018

(51) Int. Cl. H04Q 11/04; G06Q 20/10; H04B 1/401; H04L 12/801; G06Q 20/20; G06K 7/08; G07F 7/10

(52) U.S. Cl. CPC H04Q 11/0457; G06Q 20/102; H04B 1/401; G07F 7/10; G06Q 20/20; G06K 7/084; H04Q 2213/1305; H04L 47/12

(57) ABSTRACT

Exemplary embodiments include methods and systems to monitor and intelligently adopt a transaction path to deliver the fastest possible transaction time by analyzing the speed of available data channels. A client installed at a terminal device continuously monitors the speed of transactions being conducted at the terminal device. If the speed of a transaction exceeds a set threshold, then the client determines if a faster transaction path from among available channels is available based on historical transaction speed data. Alternatively, the client can ping available channels periodically to determine the transaction speed. Once a channel having a faster path is identified, the client can command the terminal device to switch to the channel having the faster path.

### BACKGROUND OF THE INVENTION

### 1. Field of the Invention

The present disclosure relates generally to the monitoring of communications channels to identify the fastest path to use. Specifically, various embodiments relate to determining whether a certain channel's network connection meets desired response times for conducting a transaction, and if not, comparing the speeds of other available channels' network connections, and if required, automatically switching to a faster channel to ensure the fastest connection for transactions.

### 2. Description of The Related Art

Typically, devices that rely upon wireless networks, such as POS terminals using cellular networks for transaction processing, suffer from either a loss in connectivity or slow connectivity due to network loading or not being connected to the most efficient (e.g., fastest) network. Indeed, peak connectivity issues have been reported to cause significant problems at major retailers to complete transactions. This results in dissatisfaction for consumers because the transaction processing speed is inefficient and causes increased waiting times for customers. Dissatisfied consumers usually take their business elsewhere, resulting in loss of revenue.

These and other deficiencies exist.

### SUMMARY OF THE INVENTION

An exemplary embodiment includes a point of sale terminal including a network interface unit that supports at least two cellular network connections, wherein the network interface establishes a first cellular network connection to a first cellular network over which it conducts a transaction; and a client configured to monitor a first transaction speed of the transaction over the first cellular network connection; wherein the client further monitors a second transaction speed of a second cellular network connection chosen from the at least two cellular network connections; and the client being configured to cause a switch from the first cellular network connection to the second cellular network connection to conduct a subsequent transaction when the first transaction speed is determined to be slower than a threshold transaction speed and the second transaction speed is faster than the first transaction speed.

Another exemplary embodiment includes a first point of sale terminal having a first client and is communicatively coupled to at least two cellular network connections for conducting a first transaction; and the first client being configured to monitor a first transaction speed of the first transaction over a first cellular network connection of the at least two cellular network connections and to compare the first transaction speed to a threshold transaction speed such that the first client is configured to cause the first point of sale terminal to switch from the first cellular network connection to a second cellular network connection chosen from the at least two cellular network connections based on comparing the monitored transaction speed to the threshold transaction speed when the monitored transaction speed exceeds the threshold transaction speed.

Another exemplary embodiment includes a method having steps including monitoring a speed of a transaction over a first cellular network, by at least one computer processor, from a point of sale terminal; comparing the speed of the transaction with a threshold transaction speed; if the speed of the transaction is slower than the threshold transaction speed, identifying a second cellular network for conducting transactions at the point of sale terminal wherein a speed of the second cellular network is faster than the speed of the transaction over the first cellular network and the second cellular network is identified based on stored, historical transaction speed data comprising transaction speed data from previous transactions conducted at the point of sale terminal collected over a period of time; and causing the point of sale terminal to switch from using the first cellular network to the second cellular network wherein the switch is caused by an installed client at the point of sale terminal.

These and other embodiments and advantages will become apparent from the following detailed description, taken in conjunction with the accompanying drawings, illustrating by way of example the principles of the various exemplary embodiments.

### BRIEF DESCRIPTION OF THE DRAWINGS

For a more complete understanding of the present invention, the objects and advantages thereof, reference is now made to the following descriptions taken in connection with the accompanying drawings in which:

FIG. 1 depicts a system according to exemplary embodiments.

FIG. 2 depicts a method according to exemplary embodiments.

FIG. 3 depicts a flow chart according to exemplary embodiments.

### DETAILED DESCRIPTION OF PREFERRED EMBODIMENTS

The following description provides different configurations and features according to exemplary embodiments. While certain nomenclature and types of applications and hardware are described, other names and application/hardware usage are possible and the nomenclature provided is done so by way of non-limiting examples. Further, while particular embodiments are described, it should be appreciated that the features and functions of each embodiment may be combined in any combination as is within the capability of one of ordinary skill in the art. The figures provide additional exemplary details regarding the present invention. It should also be appreciated that these exemplary embodiments are provided as non-limiting examples only.

Various exemplary methods are provided by way of example herein. These methods are exemplary as there are a variety of ways to carry out methods according to the present disclosure. The methods depicted and described can be executed or otherwise performed by one or a combination of various systems and modules. Each block shown in the methods represents one or more processes, decisions, methods or subroutines carried out in the exemplary method, and these processes, decisions, methods or subroutines are not necessarily carried out in the specific order outlined in the methods, nor is each of them required.

Exemplary embodiments include methods and systems to monitor and intelligently adopt a communication path (e.g., a channel) to deliver the fastest possible data path and response time from among available network connections. The term “channel” may be used herein to denote a connection path to/from a network for data exchange. Exemplary embodiments make use of data intelligence and predictive analytics to select and optimize the data path to gain the maximum speed on dynamic basis.

The various embodiments are configured to monitor channel transaction speeds and to identify the fastest communications path to use to ensure a high speed data channel to conduct transactions. For example, the embodiments may determine whether a certain channel's connection meets desired transaction response times. This information can be used to dynamically and automatically switch the data or communications channel being used to another data or communications channel to ensure a speedy data connection.

By way of non-limiting example, a transaction may be originated from a POS terminal using a cellular network connection (i.e., a channel). The time of completion for the transaction may be determined and recorded by the POS terminal. The time of completion may be measured from receipt of the payment information from a customer (e.g., swiping or tapping of the payment method at the POS terminal) to until the authorization for the transaction is returned from the payment network. This channel transaction speed monitoring may occur during each transaction conducted at the POS terminal. The channel transaction speed (i.e., the time of completion of the transaction) may be compared to a threshold number (i.e., a threshold time for completion of the transaction. This time may be predetermined). If the transaction speed is in excess of the threshold (i.e., the transaction time is longer than the threshold time for completion of the transaction), the POS terminal may evaluate historical transaction speed data from other available channels it can access to provide a network connection. The POS terminal may determine and store the historical channel transaction speed data from other available channels based on previous transactions transacted over those channels by the POS terminal, transaction speed data for other channels provided to the POS terminal from a central server, or by monitoring the transaction speeds of alternate channel connections by sending a ping (e.g., conducting a $0 dollar, or test, transaction). Any other method of determining the transaction speeds of available channels may be employed. If an alternate, available channel has better performance than the current channel (i.e., its transaction speed is faster than the threshold or faster than the transaction speed of the current channel), the POS terminal may switch or transition to using the alternate, available channel instead of the current channel. In some instances, a transition to another available channel may occur even if its transaction speed is slower than the threshold. This might occur, for example, if all available channels' transaction speeds are slower than the threshold, but one of the channels is faster than the others.

Alternatively, the POS terminal may actively monitor the transaction speeds of all, or a subset of, available cellular networks (i.e., available channels). The monitoring may be performed by maintaining historical data of transactions conducted over the available channels and pinging each available channel to determine the transaction speed of each. In this manner, the POS terminal may monitor the channel speed periodically using test transactions, apart from actual transactions, and identify the fastest channel. The POS terminal may also receive data from a central server that indicates the speed of each available channel. The central server may ping available channels and determine the speed of each. Alternatively, the central server may collect data on transaction speed conducted by the POS terminal on each available channel. Other methods of determining the transaction speed of available channels might also be employed. If a faster channel is available (i.e., a connection with faster transaction speeds than the current channel being utilized to conduct transactions), the POS terminal may automatically switch to using the faster channel. The POS terminal may continuously monitor transaction speed of available channels and ensure it is using the fastest connection. Once identified, that channel may be used for transactions conducted before a new determination is made. Thus, the transaction may be completed using the fastest channel.

Exemplary embodiments may include two modes: single ended and dual ended. In the single ended mode, an intelligent client may be installed at the POS terminal side. The intelligent client may be implemented as software. Transactions at the POS terminal are monitored by the client, creating a continuous tracking of the various transactions (e.g., debit, credit, limit, acquirer, brand, bank, etc.) to build a model that consists of parameters such as, but not limited to, average, mean, and best transaction speeds for transactions. Depending on the thresholds set, the client software may automatically trigger a switch of the current channel to another channel to provide the fastest speed. The switch can be triggered once transaction speeds are slower than the threshold. The switch may be to a faster channel based on the model data. In various embodiments, the intelligent client can trigger pings during idle cycles to constantly monitor the health of the current channel and available channels to collect the statistics vital for intelligent decision making regarding the fastest available channel.

In an alternative single ended mode, an intelligent client may be installed at the gateway or server side. The intelligent client may be implemented as software. Transactions conducted by each POS terminal communicatively coupled to the gateway are monitored by the client, creating a continuous tracking of the various transactions (e.g., debit network, credit, limit, acquirer, brand, bank, etc.) to build a model that consists of parameters such as average, mean, and best transaction speeds for each channel used by each POS terminal. The client may trigger a switch, at the POS terminal, of the current channel being used to another channel to provide the fastest speed. The switch can be triggered once the speed information on the channel being used by the POS terminal is slower than the threshold. The switch may be to a faster channel based on the model data. In various embodiments, the intelligent client can trigger pings during idle cycles to constantly monitor the health of the current channel or channels to collect the statistics vital for intelligent decision making regarding the fastest available channel for each POS terminal it serves.

In the dual ended mode, a client may reside at both the terminal side and on the gateway or server side. The gateway may be a payment network gateway to which multiple POS terminal connect to conduct transactions. The server client may monitor and record the transaction speed for each of the multiple connected POS terminals for each available channel used by the POS terminal. Thus, the gateway client can monitor data relating to a particular POS terminal and also has the data for all the transactions carried out by each connected POS terminal. In various embodiments, through an API, each POS terminal and the gateway are able to exchange the data related to optimizing the transaction speeds and adopt to the best possible channel in a proactive fashion. This exchanged data is put into the model at the POS terminal and can be used for channel selection decision making based on channel transaction speed. For example, the gateway client can provide each POS terminal client with data on transaction speeds for each available channel, enabling the client at the POS terminal to evaluate transaction speeds on each available channel based on a larger data set (i.e., the data collected by the POS terminal and the data collected by the gateway). According to exemplary embodiments, the POS terminal controls the switching of channels.

The use of the term “POS terminal” is meant to be exemplary and non-limiting. For example, the POS terminal according to exemplary embodiments may be any type of POS device, including PIN pads, electronic cash registers, Automated Teller Machines (ATMs), card payment terminals, card readers/controllers, and the like, as well as unattended POS devices, such as petrol kiosks. The POS terminal may rely upon cellular networks or data channels for sending and receiving data to complete a transaction. Further, the cellular network according to exemplary embodiments may use any type of wireless data transmission protocol. For example, the cellular network may use protocols such as WIFI, 3G, 4G, GSM, and CDMA. Further, it should be appreciated that the use of the term “channel,” “transmission channel,” or “transmission” is meant to be non-limiting and may represent communication paths that are either simplex or duplex in nature.

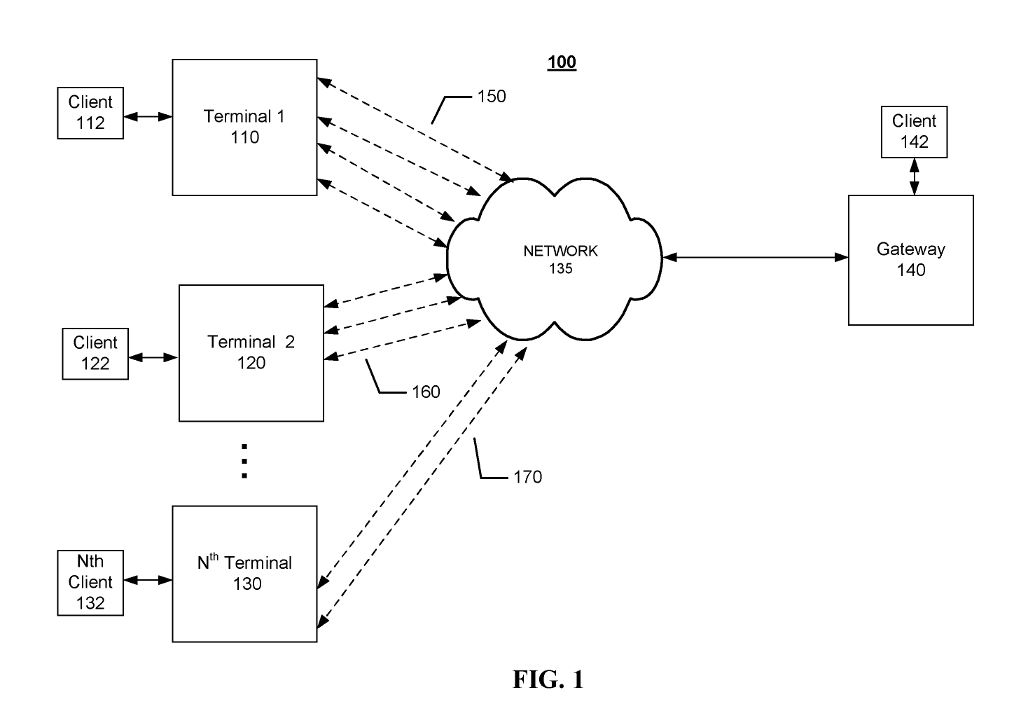

Referring to FIG. 1, a schematic diagram of a system 100 is shown, according to an exemplary embodiment. The system 100 of FIG. 1 may be implemented in a variety of ways. Architecture within system 100 may be implemented as hardware components (e.g., modules) within one or more network elements. It should also be appreciated that architecture within system 100 may be implemented in computer executable software (e.g., on a tangible, non-transitory computer-readable medium) located within one or more network elements. Module functionality of architecture within system 100 may be located on a single device or distributed across a plurality of devices including one or more centralized servers and one or more mobile units or end user devices. The architecture depicted in system 100 is meant to be exemplary and non-limiting. For example, while connections and relationships between the elements of system 100 is depicted, it should be appreciated that other connections and relationships are possible. The system 100 described below may be used to implement the various methods herein, by way of example. Various elements of the system 100 may be referenced in explaining the exemplary methods described herein.

The system 100 may have a first terminal 110, a second terminal 120, and a Nth terminal 130. These terminals (i.e., 110, 120 and 130) may be communicatively coupled via one or more communication paths 150, 160, and 170 to a network 135. According to exemplary embodiments, each terminal 110, 120, and 130 may be a POS terminal.

According to exemplary embodiments, the network 135 may be the Internet. In various embodiments, the network 135 may be a non-public network, such as a local area network. In other embodiments, the network 135 may be a combination of networks.

Each terminal 110, 120, and 130 may be communicatively coupled to the network 135 via one or more channels, or network connections, 150, 160 and 170. For example, terminal 110 could have four different channels 150; device 120 could have three different channels 160, and Nth device 130 could have two channels 170. It should be appreciated that these examples are meant to be exemplary and each terminal 110, 120, and 130 may have more or less channels than depicted in FIG. 1. Each channel may represent a data transmission (and receipt) path from (and to) the terminal. According to exemplary embodiments, the channels 150, 160, and 170 may be cellular networks. For example, the four data exchange paths depicted at 150 may represent four different cellular networks, each providing a data channel to the network 135, which may be operated by different cellular providers and may operate under the same or different network protocols (e.g., such as GSM, 3G, CDMA, or LTE). In various embodiments, different combinations of channels and networks are possible.

A gateway 140 may be communicatively coupled to the network 135. The gateway 140 may be a payment network gateway. For example, the gateway 140 may be a payment gateway that facilitates a payment transaction from a POS terminal (such as 110, 120, and 130) by the transfer of information between the terminal and the front end processor or acquiring bank.

Each terminal 110, 120, and 130 may have a client associated therewith (i.e., clients 112, 122, and 132). The gateway 140 may have a client 142 associated therewith. The client 142 may be used in a dual ended configuration as described herein. The client 142 may communicate with the clients 112, 122, and 132.

In various embodiments, only the terminals 110, 120, and 130 may have a client associated therewith and the gateway 140 may not have a client. This may be the single ended configuration described herein. Alternatively, as described above, the gateway may have a client associated therewith in the single ended configuration.

According to exemplary embodiments, each device client (e.g., clients 112, 122, and 132) may be an intelligent client that monitors transactions conducted using the various data exchanges paths (e.g., one or more of the channels 150, 160, and 170). The device client may be implemented as software. In various embodiments, the device client may be hardware. In other embodiments, the client may be a combination of hardware and software. The client monitors the speed of transactions from the POS terminal on the current channel. For example, the time for completion of a transaction from presentment (e.g., insertion, swipe, or tapping) of a customer's payment card or payment device until the transaction approval is received by the client may be measured by the client and stored by the client. In this way, through monitoring, the client can build a model that consists of various transaction speed information for each channel. For example, the model may track average, mean, and best speeds on each path for transactions conducted. The model may also track data channel quality (i.e., signal strength and/or quality).

The client may be configured with a threshold time or speed for transactions. When the transaction speed exceeds this threshold time, the client may search for a faster channel amongst the channels available to the terminal. The faster channel may be determined by an analysis of the stored model information of transaction times. Once a faster channel is determined, the client may cause the terminal to switch to the faster channel. For example, the client may cause the terminal's communication controller to switch to the faster channel. Thus, the client provides management of the terminal's data communication path.

The monitoring and determination of channel transaction speed may be done continuously while the terminal is in operation. In various embodiments, when the transaction speed threshold is exceeded, the client may cause the terminal to ping the other available channels to determine the speed of the available channels. For example, the client may cause a $0 dollar, or test, transaction to be initiated and measure the speed on each available channel. In other embodiments, such as the dual ended embodiment, the gateway, from its client, may provide speed information on the various available channels based on data collected from the POS terminal, or in some embodiments, all of the terminals to which the gateway is connected. The gateway (i.e., the gateway's client) may provide channel information (e.g., transaction speed) to each terminal client at periodic intervals or the terminal client may query the gateway client for channel transaction speed information. This provided information may be integrated into the terminal client's model of transaction speed and used in determination of channel speed.

In some embodiments, the client may reside at the gateway. The gateway may monitor the transaction speed information on each available channel. The gateway client may determine the fastest available channel and cause the POS terminal to switch channels.

According to various embodiments, the client may monitor channel transaction speed at predetermined intervals or during certain environment conditions, apart from actual transactions. This monitoring may be done in addition to the monitoring of actual transaction time. For example, the client may trigger pings (e.g., test transactions) during idle cycles to constantly monitor the speed of the current channel and the other available channels to collect the statistics (e.g., speed information) as data for decision making. Through this monitoring, the client can build a model that consists of various speed information. For example, the model may track average, mean, and best speeds on each path. The model may also track data channel quality (i.e., signal strength and/or quality). If the ping data on the current channel indicates that the transaction time exceeds a threshold, then the client may automatically trigger a switch of the channel to one that provides the fastest speed. Additionally or alternatively, the switch may occur once a determination is made that a faster transmission path is available. In various embodiments, the switch may be independent of any transaction or other data exchange event triggered by the device or the server.

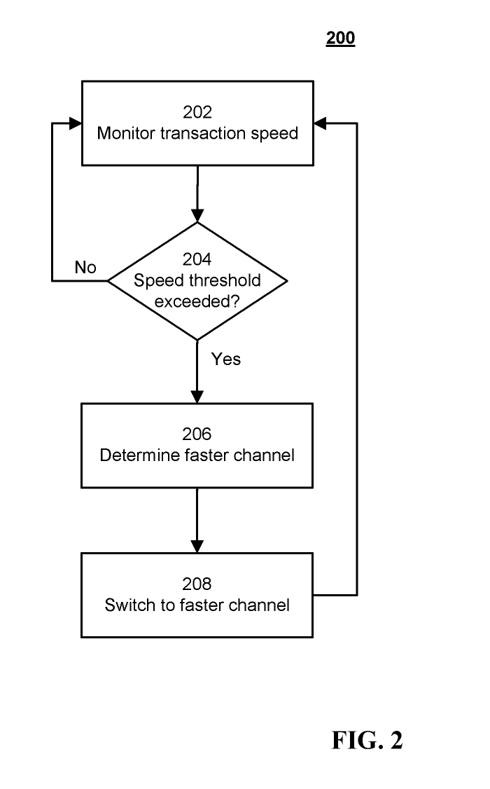

FIG. 2 depicts a method according to exemplary embodiments for dynamically selecting a best data transmission channel.

At block 202, transaction speed is monitored at a POS terminal by an installed client. The transaction speed may be monitored for each transaction conducted by the POS terminal. According to exemplary embodiments, the transaction may be conducted over a cellular network (i.e., a channel) to connect to a payment gateway or server through a data network (e.g., the Internet).

At block 204, a determination whether a speed threshold is exceeded is made. If the speed threshold is not exceeded, then the current channel is continued to be used and the method returns to block 202 and transaction speed is continued to be monitored.

At block 206, if the speed threshold is exceeded, a faster channel is determined. The faster channel may be determined as described above based on historical transaction speed information, based on a ping of other available channels, based on data provided by a gateway client, and/or based on a combination of the preceding.

At block 208, the data transmission path is switched to the faster data channel.

The method may be repeated.

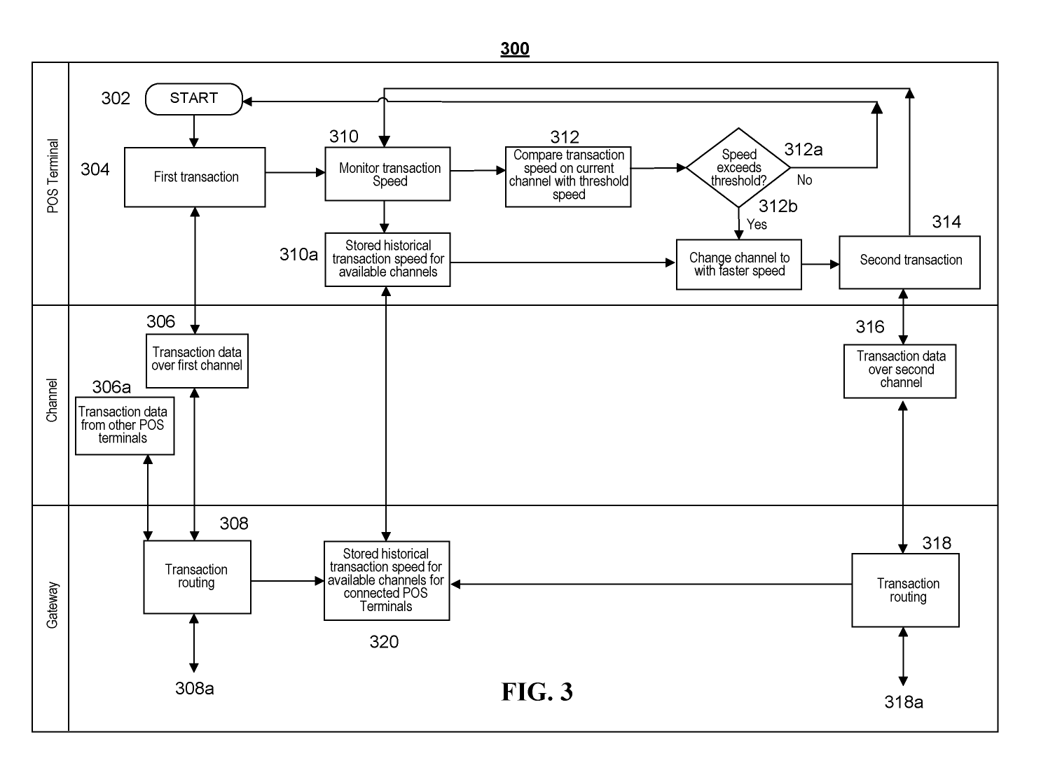

FIG. 3 depicts a flow chart according to exemplary embodiments. The flow chart 300 may start at 302 at a POS terminal. At 304, a first transaction may be originated from the POS terminal. The POS terminal may using a first cellular network connection as the connection channel. At 306, the POS terminal transmits the transaction data to a data network over this first channel. The transaction data is transmitted to a gateway at block 308. The gateway performs further transaction routing to the appropriate payment processor or acquirer at block 308a. The transaction data is returned through the gateway over the first channel to the POS terminal to complete the transaction. As depicted at block 306a, the gateway may be communicatively coupled to more than one POS terminal. Thus, the gateway may perform transaction routing for a plurality of POS terminals.

The time of completion for the transaction may be determined and recorded by the POS terminal at block 310. The time of completion may be measured from receipt of the payment information from a customer (e.g., swiping or tapping of the payment method at the POS terminal) to until the authorization for the transaction is returned from the payment network. This channel transaction speed may be stored at block 310a.

At block 312, the channel transaction speed may be compared to a threshold number (i.e., a threshold time for completion of the transaction). If the transaction speed does not exceed the threshold speed, the flow may return to the start at 302 and process another transaction using the first channel at shown at block 312a.

If the transaction speed is in excess of the threshold, the POS terminal may evaluate historical transaction speed data from other available channels at block 312b. The POS terminal may transition to a second, faster channel and conduct the next transaction using this second faster channel at blocks 314 and 316. At blocks 318 and 318a, the second transaction may be routed by the gateway.

At block 320, the gateway may monitor and store the transaction speed for each transaction from each of its POS terminals over each channel. This transaction speed data may be provided to each POS terminal and used in the POS terminal's evaluation of transaction speed and identifying faster channels. According to exemplary embodiments, the transaction speed data provided by the gateway may be specific to the POS terminal to which it is being provided. The transaction speed data may be provided to the POS terminal over the same data channel used for transaction data. In some embodiments, a different data channel may be used to provide the transaction speed data. In some embodiments, each POS terminal may provide its transaction speed data to the gateway. The gateway may add this data to its data set of transaction speed data. The gateway may thus store and provide aggregated transaction speed information to each POS terminal.

It should be appreciated that the use of the reference labels “first” and “second” (e.g., “first transaction,” “second transaction,” etc.) are for illustrative purposes. The flow of FIG. 3 may be repeated for each transaction.

It will be appreciated by those skilled in the art that the various embodiments are not limited by what has been particularly shown and described hereinabove. Rather the scope of the various embodiments includes both combinations and sub-combinations of features described hereinabove and variations and modifications thereof which are not in the prior art. It should further be recognized that these various embodiments are not exclusive to each other.

It will be readily understood by those persons skilled in the art that the embodiments disclosed here are susceptible to broad utility and application. Many embodiments and adaptations other than those herein described, as well as many variations, modifications and equivalent arrangements, will be apparent from or reasonably suggested by the various embodiments and foregoing description thereof, without departing from the substance or scope of the above description.

Accordingly, while the various embodiments have been described here in detail in relation to exemplary embodiments, it is to be understood that this disclosure is only illustrative and exemplary and is made to provide an enabling disclosure. Accordingly, the foregoing disclosure is not intended to be construed or to limit the various embodiments or otherwise to exclude any other such embodiments, adaptations, variations, modifications or equivalent arrangements.

For example, it should be appreciated that while exemplary embodiments have been described in terms of a transaction, a POS terminal, and a gateway, these embodiments are meant to be exemplary and non-limiting as there are other applications for exemplary embodiments. For example, the various embodiments may be used in any system that requires data exchange over a network using one or more channels to connect to the network.

1. A point of sale terminal, comprising:
a network interface unit that supports at least two cellular network connections, wherein the network interface establishes a first cellular network connection to a first cellular network over which it conducts a transaction; and
a client configured to monitor a first transaction speed of the transaction over the first cellular network connection;
wherein the client further monitors a second transaction speed of a second cellular network connection chosen from the at least two cellular network connections; and
the client being configured to cause a switch from the first cellular network connection to the second cellular network connection to conduct a subsequent transaction when the first transaction speed is determined to be slower than a threshold transaction speed and the second transaction speed is faster than the first transaction speed.

2. The point of sale terminal of claim 1, wherein the client further comprises a model comprising historical transaction speed information for each of the at least two cellular network connections.

3. The point of sale terminal of claim 2, wherein the historical transaction speed information comprises transaction speed information from past transactions conducted by the point of sale terminal.

4. The point of sale terminal of claim 2, wherein the client receives network connection speed information from a second client located remote from the first client that is used in the model to determine the second transaction speed of the second cellular network connection.

5. The point of sale terminal of claim 1, wherein the client is further configured to test transaction speed of the at least two cellular network connections at periodic intervals using a test transaction.

6. A system, comprising:
a first point of sale terminal comprising a first client and the first point of sale terminal is communicatively coupled to at least two cellular network connections for conducting a first transaction; and
the first client being configured to monitor a first transaction speed of the first transaction over a first cellular network connection of the at least two cellular network connections and to compare the first transaction speed to a threshold transaction speed such that the first client is configured to cause the first point of sale terminal to switch from the first cellular network connection to a second cellular network connection chosen from the at least two cellular network connections based on comparing the monitored transaction speed to the threshold transaction speed when the monitored transaction speed is below the threshold transaction speed.

7. The system of claim 6, further comprising:
a second point of sale terminal comprising a second client and the second point of sale terminal is communicatively coupled to at least two cellular network connections for conducting a second transaction; and
the second client being configured to monitor a second transaction speed of the second transaction over the first cellular network connection of the at least two cellular network connections and to compare the second transaction speed to a threshold transaction speed such that the second client is configured to cause the second point of sale terminal to switch from the first cellular network connection to the second cellular network connection chosen from the at least two cellular network connections based on comparing the monitored transaction speed to the threshold transaction speed when the monitored transaction speed is below the threshold transaction speed.

8. The system of claim 6, wherein the first client further comprises a model comprising historical transaction speed information for each of the at least two cellular network connections.

9. The system of claim 6, wherein the historical transaction speed information comprises transaction speed information from past transactions conducted by the first point of sale terminal.

10. The system of claim 7, wherein the first client further comprises a model comprising historical transaction speed information for each of the at least two cellular network connections and the first client receives channel transaction speed information from the second client that is used in the model to determine the second, faster connection.

11. The system of claim 6, wherein the first client is further configured to test transaction speed at periodic intervals using a test transaction.

12. A method, comprising:
monitoring a speed of a transaction over a first cellular network, by at least one computer processor, from a point of sale terminal;
comparing the speed of the transaction with a threshold transaction speed;
if the speed of the transaction is slower than the threshold transaction speed, identifying a second cellular network for conducting transactions at the point of sale terminal wherein a speed of the second cellular network is faster than the speed of the transaction over the first cellular network and the second cellular network is identified based on stored, historical transaction speed data comprising transaction speed data from previous transactions conducted at the point of sale terminal collected over a period of time; and
causing the point of sale terminal to switch from using the first cellular network to the second cellular network wherein the switch is caused by an installed client at the point of sale terminal.

13. The method of claim 12, further comprising:
storing the speed of the transaction in the stored, historical transaction speed data.

14. The method of claim 12, further comprising:
receiving a set of transaction speed data from a remote gateway, wherein the set of transaction speed data comprises transaction speed data from a plurality of point of sale terminals.

15. The method of claim 14, further comprising:
using the received set of transaction speed data in the step of identifying a second cellular network in addition to the stored, historical transaction speed data.
